(19) United States
(12) Patent Application Publication
(10) Pub. No.: US 2014/0314587 A1
(43) Pub. Date: Oct. 23, 2014

(54) Check Valve Device In The Suction Side of A Hydrostatic Power-Unit That Can Be Operated In The Same Direction of Rotation As A Pump And As A Motor

(71) Applicant: Linde Hydraulics GmbH & Co. KG, Aschaffenburg (DE)

(72) Inventors: Lukas Krittian, Aschaffenburg (DE); Alfred Langen, Aschaffenburg (DE)

(73) Assignee: Linde Hydraulics GmbH & Co. KG, Aschaffenburg (DE)

(21) Appl. No.: 14/184,807

(22) Filed: Feb. 20, 2014

(30) Foreign Application Priority Data
Feb. 22, 2013 (DE) 102013101796.7
Feb. 26, 2013 (DE) 102013101868.8

(51) Int. Cl. F02B 73/00

(52) U.S. Cl. CPC F02B 73/00
USPC 417/364; 137/511

(57) ABSTRACT

A hydrostatic power-unit (7) is connected with an internal combustion engine (2). The suction side (S) of the power-unit (7), when operating as a pump, sucks hydraulic fluid from a tank (9) and delivers into a delivery side (P), and when operating as a motor is driven by hydraulic fluid from a hydraulic accumulator (20). A check valve device (30) is located in the suction side (S) to provide a pressure increase when the power-unit (7) is operated as a motor. The check valve device (30) has a check valve (32) operated by an actuator device (31). The actuator device (31) actuates the check valve (32) between a closed position (32a) in which a connection of the suction side (S) with the tank (9) is shut off, and an open position (32b) in which the connection of the suction side (S) to the tank (9) is opened.

### CROSS REFERENCE TO RELATED APPLICATIONS

This application claims priority to German Application Nos. DE 102013101796.7 filed Feb. 22, 2013 and DE 102013101868.8 filed Feb. 26, 2013, both of which are herein incorporated by reference in their entirety.

### BACKGROUND OF THE INVENTION

1. Field of the Invention

This invention relates to a check valve device of a hydrostatic power-unit that is in a drive connection with an internal combustion engine and can be operated as a pump and as a motor. The power-unit, when operating as a pump, sucks hydraulic fluid from a tank on a suction side and delivers into a delivery side and, when operated as a motor, is driven by hydraulic fluid under pressure taken from a hydraulic accumulator and fed via the suction side. The check valve device is located in the suction side of the hydrostatic power-unit to achieve an increase in pressure on the suction side when the power-unit is operated as a motor.

2. Description of Related Art

Self-propelled mobile machines, in particular industrial trucks, agricultural equipment, forestry equipment, and construction equipment, such as excavators, wheeled and telescoping loaders, tractors, combine harvesters, forage harvesters, and sugar beet and potato diggers, have a drivetrain with an internal combustion engine that drives a traction drive and also the working hydraulics that perform the work functions of the machine. At least one hydraulic pump driven by the internal combustion engine is provided to supply the working hydraulics with hydraulic fluid.

During idle operation, when the traction drive and the working hydraulics are not actuated and no torque is required from the internal combustion engine, the internal combustion engine is operated at a lower idle speed. Idle operation of this type occurs during pauses or interruptions in the work.

To reduce the fuel consumption of the internal combustion engine during pauses or interruptions in work, a start-stop function can be provided for the internal combustion engine in which the internal combustion engine, operating at no load, is shut off during pauses or interruptions in work and is automatically restarted when there is a demand for torque from a work function or from the traction drive. The shutoff and subsequent restarting of the internal combustion engine can occur even after relatively brief idle times, so that the starting process of the internal combustion engine is an operation that must be carried out relatively frequently and at brief intervals during the operation of the internal combustion engine. This requirement places severe demands on the starter device of the internal combustion engine with regard to fatigue strength and the ability to deliver the starting energy required to start the internal combustion engine.

In mobile machines, hydrostatic power-units are used as hydraulic starters of the internal combustion engine for the start-stop function and are in a drive connection with the crankshaft of the internal combustion engine. During startup of the internal combustion engine, these hydraulic starters are operated with hydraulic fluid from a hydraulic accumulator, which accumulator is charged before the shutoff of the internal combustion engine. DE 10 2011 105 006 A1 describes a drivetrain in which, in addition to the hydraulic pump of the working hydraulics, an additional hydraulic motor is provided that functions as a starter of the internal combustion engine to provide the start-stop function. Because the additional hydraulic motor is in coupled motion during the normal operation of the running internal combustion engine, losses occur that reduce the overall efficiency of the machine. The presence of an additional hydraulic motor as the starter of the internal combustion engine also requires additional construction cost and effort and occupies additional space.

To eliminate the cost and effort required for an additional hydraulic motor as a starter for the internal combustion engine on mobile machines with a start-stop function, the hydraulic pump that is already present for the working hydraulics can be used as the hydraulic starter of the internal combustion engine by operating the hydraulic pump in the same direction of rotation and same direction of flow of the hydraulic fluid as a motor by supplying hydraulic fluid from a hydraulic accumulator to the suction side which is connected to a tank. As a general rule, the hydraulic pump of the working hydraulics is operated in an open circuit and is in communication on a suction side with a suction connection for a hydraulic fluid tank, and delivers the hydraulic fluid into a delivery line connected to a delivery connection. When operated as a pump, in which the hydraulic pump is driven by the running internal combustion engine, the hydraulic pump sucks hydraulic fluid via the suction side out of the tank and delivers it into the delivery line to supply the users of the working hydraulics. If the hydraulic pump is pressurized on the suction side with hydraulic fluid under pressure from a hydraulic accumulator, the hydraulic pump functions as a motor in the same direction of rotation of the hydrostatic power-unit and in the same direction of flow of the hydraulic fluid. This makes it possible to generate a torque on the crankshaft of the internal combustion engine to start the internal combustion engine for the start-stop function and/or to deliver additional torque to the crankshaft to supply additional power and assist the running internal combustion engine by acting as a booster drive when the internal combustion engine is running.

The booster drive achieved by operating the hydraulic pump of the working hydraulics as a motor while the internal combustion engine is running makes it possible to reduce the power consumption of the internal combustion engine. As a result of the hydrostatic booster drive, the output of the internal combustion engine can also be reduced. A downsizing of the internal combustion engine has advantages in terms of compliance with emissions regulations.

With a hydrostatic power-unit operated as a pump and as a motor in the same direction of rotation and the same direction of flow of the hydraulic fluid, to operate as a motor, it is necessary to locate a check valve (that closes in the direction of flow to the tank) in the suction side of the power-unit. The check valve is closed when the power-unit is operated as a motor and, thus, makes possible an increase in pressure in the suction side and prevents the hydraulic fluid fed from the hydraulic accumulator to the suction side from flowing back to the tank.

Hydrostatic power-units in the form of working hydraulic pumps are known from FIGS. 1 and 2 of WO 2012/125798 A1 and EP 2 308 795 A1. These power-units can be used to supply the users of the working hydraulics with hydraulic fluid when operated as a pump, and can be operated in the same direction of rotation as a motor to function as a hydraulic starter and/or as a booster drive of the internal combustion engine. To achieve a pressure increase when operating as a motor, when the suction side of the hydrostatic power-unit is in communication with a tank and is fed with hydraulic fluid from a hydraulic accumulator, a check valve that shuts off the flow in the direction of the tank is located in the suction side.

The hydraulic pump, such as an axial piston machine, of the working hydraulics is generally designed with a high suction limit speed for operation as a pump. The suction side, which is connected with the tank when the power-unit is operated as a pump, and the suction connection of the hydrostatic power-unit therefore have a relatively large cross section. In FIGS. 1 and 2 of WO 2012/125798 A1 and EP 2 308 795 A1, the check valve located in the suction side of the hydrostatic power-unit that shuts off the flow to the tank is a conventional pressure-actuated check valve, for example a ball check valve. When the power-unit is operated as a pump, the check valve is actuated into an open position by the suction pressure in the suction side. However, in the open position during operation of the power-unit, conventional pressure-actuated check valves create additional hydraulic resistance in the suction side and create an additional flow resistance in the suction side of the hydrostatic power-unit. These cause additional pressure losses in the suction side of the hydrostatic power-unit, which reduce the suction limit speed of the power-unit when it is operated as a pump.

### SUMMARY OF THE INVENTION

An object of this invention is to provide a check valve in the suction side of a hydrostatic power-unit operable in the same direction of rotation as a pump and as a motor, such that when the power-unit is operated as a motor, hydraulic fluid is fed to the power-unit from a hydraulic accumulator on the suction side, and when the power-unit is operated as a pump with an open check valve device, there is no adverse effect on the suction limit speed of the power-unit.

This object is accomplished in that the check valve device of the invention has a check valve that can be actuated by an actuator device. The actuator device can actively actuate the check valve between a closed position, in which a connection between the suction side and the tank is cut off in the direction of flow from the suction side to the tank; and an open position, in which the connection between the suction side and the tank is opened. A check valve that can be actively actuated between a closed position and an open position by an actuator device has the advantage over pressure-actuated check valves of the known art in that the check valve can be designed so that in the open position the check valve does not represent any additional hydraulic resistance in the suction side and, therefore, causes no additional flow resistance in the suction side. With the check valve of the invention that can be actively controlled by the actuator device, it becomes possible for a hydrostatic power-unit (which, when operated as a pump, supplies a user such as the working hydraulic system) to be operated as a motor so that the power-unit functions as a hydraulic starter of the internal combustion engine and/or as a booster drive to assist the internal combustion engine without causing a reduced suction limit speed when operated as a pump.

In one preferred embodiment of the invention, the check valve can be actuated by the actuator device into the open position when the power-unit is operated as a pump and into the closed position when the power-unit is operated as a motor. The actuator device makes it possible in a simple manner to actively move the check valve into the open position when the power-unit is operated as a pump, to achieve pump operation of the hydrostatic power-unit without creating additional flow resistance in the suction side, and to actively actuate the check valve into the closed position for operation of the hydrostatic power-unit as a motor to provide a drive by the power-unit by means of the hydraulic fluid fed to the suction side from the hydraulic accumulator.

It is particularly advantageous if the check valve can be actuated by a spring device into the closed position, and the check valve can be actuated into the open position by a hydraulic actuation pressure applied to the actuator device. A simple control and actuation of the check valve can be achieved with a hydrostatic control system with this type of actuator device. Additional advantages are achieved if the actuator pressure is generated only when the internal combustion engine is running. When the internal combustion engine is shut off and there is no actuation pressure, the check valve is actuated by the spring device into the closed position, so that when the hydrostatic power-unit is used as a hydraulic starter of the internal combustion engine, the power-unit can be immediately operated as a motor during startup of the internal combustion engine without having to first actuate the check valve into the closed position.

In one preferred embodiment of the invention, the check valve in the closed position is acted upon by the pressure from the hydraulic accumulator connected on the suction side into the closed position. As a result, the check valve is held in the closed position by the pressure from the hydraulic accumulator on the suction side for the duration of the startup of the internal combustion engine. This prevents the check valve from being actuated into the open position before the end of the startup process by the actuation pressure generated when the internal combustion engine is running.

In one preferred embodiment of the invention, the actuator device is a positioning piston in an operative connection with the check valve. With a positioning piston, it is possible in a simple manner to achieve an active actuation of the check valve between the closed position and the open position.

In one advantageous embodiment of the invention, the positioning piston is actuated by the spring device and has a piston pressure chamber that can be pressurized with the actuation pressure and counteracts the spring device. It thereby becomes possible with little construction effort or expense for the check valve to be actuated into the closed position by the spring device and into the open position by the actuation pressure.

The spring device is advantageously located in a spring-side piston pressure chamber of the positioning piston, which can be placed in communication with the tank. When the actuation pressure is present, the positioning piston can be moved against the pressure of the spring device, and the check valve can be actuated into the open position.

In an alternative embodiment of the invention, the actuator device is a control pressure surface located on the check valve and can be actuated by the hydraulic actuation pressure, which actuates the check valve toward the open position. With a control pressure surface on the check valve, an active actuation of the check valve between the closed position and the open position can be achieved and it can be achieved in a simple manner and with little construction effort and expense that the check valve can be actuated into the closed position by the spring device and into the open position by the actuation pressure.

In one advantageous embodiment of the invention, the check valve is a flapper valve with a pivotable flapper, which is in an operative connection with the actuator device. A flapper valve makes possible a compact and space-saving construction of the check valve and can, with little construction effort or expense, be actuated with an actuator device in the form of a positioning piston. With a flapper valve, it is possible to hold the flapper valve in the closed position in a simple manner during startup of the internal combustion engine by the pressure of the hydraulic accumulator present on the suction side of the power-unit.

In one embodiment of the invention, the positioning piston can be in an operative connection with the flapper through the interposition of a tie rod, such as a swing arm, which is connected in an articulated manner to the flapper and to the positioning piston. With a tie rod connected in an articulated manner, the pivotable flap of the flapper valve can be actuated in a simple manner by the linear movement of the positioning piston.

As an alternative to an interposed tie rod, the positioning piston can be connected directly in an articulated manner with the flapper, with the articulated connection comprising a slot. If the articulated connection between the positioning piston and the pivotable flapper comprises a slot, it is also possible to actuate the pivotable flapper of the flapper valve by a linear movement of the positioning piston.

It is particularly advantageous if the flapper is located in a suction channel so that it can pivot and also so that the flapper does not project into the suction channel when in the open position. Consequently, the flapper in the open position does not cause any additional hydraulic resistance and no additional flow resistance in the suction side of the power-unit during its operation as a pump.

In one alternative embodiment of the invention, the check valve is a valve with a flat slider that can move longitudinally and is in an operational connection with the actuator device. A valve with a flat slider also makes possible a compact and space-saving construction of the check valve and can, with little construction effort or expense, be actuated with an actuator device in the form of a positioning piston or a control pressure surface. In addition, with a valve with a flat slider, the slider in the open position does not cause any additional flow resistance in the suction side of the power-unit during operation as a pump.

In an additional alternative embodiment of the invention, the check valve is a piston spool valve with a piston that can be displaced longitudinally or can be rotated and is in an operative connection with the actuator device. A piston spool valve also makes possible a compact and space-saving construction of the check valve and can be actuated with little construction effort or expense with an actuator device in the form of a positioning piston or a control pressure surface. In addition, on a piston spool valve, the preferably cylindrical piston, when in the open position, causes no additional flow resistance in the suction side of the power-unit during operation as a pump.

Alternatively, the check valve can be a ball valve with a rotatable ball and in an operative connection with the actuator device. A ball valve also makes possible a compact and space-saving construction of the check valve and can be actuated with little construction effort or expense with an actuator device in the form of a positioning piston or a control pressure surface. In addition, with a ball valve, it is possible in a simple manner to ensure that the ball, in the open position, creates no additional flow resistance in the suction side of the power-unit during operation as a pump.

The invention further relates to a hydrostatic power-unit which can be in a drive connection with an internal combustion engine and can be operated as a pump or as a motor. The power-unit, when operated as a pump, sucks hydraulic fluid on a suction side from a tank and delivers to the delivery side. When operated as a motor, the power-unit is driven by hydraulic fluid under pressure fed from a hydraulic accumulator via the suction side (which is in communication with the tank). A check valve device of the invention is located in the suction side of the power-unit. With a check valve device of the invention located in the suction side of the power-unit, and actively actuable with the actuator device between the closed position and the open position, the power-unit can be operated as a motor with little additional effort and expense so that the power-unit can be used as a hydraulic starter for the internal combustion engine to achieve a start-stop function and/or as a booster drive to assist the running internal combustion engine.

The suction side of the hydrostatic power-unit can be a suction channel or suction line.

In one embodiment of the invention, the check valve device is installed in a housing of the power-unit. The check valve device can be integrated into the housing of the power-unit with little construction effort and can be located in the segment of the suction channel that is in the housing.

Alternatively, the check valve device can have an independent housing. It thereby becomes possible in a simple matter to add the check valve device of the invention to an existing power-unit to achieve the additional operation of the power-unit as a motor so that it can function as a hydraulic starter and/or function as a booster drive.

The housing of the check valve can be connected by a flange to the housing of the power-unit. If the housing of the check valve device is constructed so that it can be connected by a flange to the housing of the power-unit in the area of the suction connection, an existing power-unit can be provided with the check valve of the invention with little additional construction effort or expense to make it possible to additionally operate the power-unit as a motor to function as a hydraulic starter and/or a booster drive.

If a control valve is provided to control the connection of the hydraulic accumulator with the suction side of the power-unit for operation as a motor, it is possible in a simple manner to connect the suction side of the power-unit operating as a motor with the hydraulic accumulator.

The power-unit can be a constant displacement power-unit, i.e., a power-unit with a constant displacement volume.

Alternatively, the power-unit can be a variable displacement power-unit in which the displacement volume can be varied by a displacement volume control device actuated by a control device. The control device can be connected to a charging pressure circuit to supply it with hydraulic fluid and can be connected with the hydraulic accumulator. A hydraulic or electro-hydraulic control device can be supplied in a simple manner with hydraulic fluid by the connection with the charging pressure circuit and/or the hydraulic accumulator for variation and actuation of the displacement volume control device. The connection of the control device with the hydraulic accumulator makes it possible in a simple matter, when the power-unit is operated as a motor and as a hydraulic starter, to vary the displacement volume of the displacement volume control device of the power-unit during startup of the shut-off internal combustion engine toward the maximum displacement volume with hydraulic fluid from the charged hydraulic accumulator, thus generating an appropriate torque to start the internal combustion engine from the hydraulic fluid flowing to the suction side from the hydraulic accumulator.

It is particularly advantageous to install a shutoff valve, in particular a check valve that shuts off the flow to the charging pressure circuit, in the connection between the control device and the charging pressure circuit. With a check valve of this type, during startup of the shut-off internal combustion engine, it is possible to supply only the control device of the power-unit with hydraulic fluid from the hydraulic accumulator and to isolate the other users of the charging pressure circuit from the hydraulic accumulator. Thus, the hydraulic fluid present in the hydraulic accumulator is effectively available for the operation of the power-unit as a motor.

For this purpose, the hydraulic accumulator is advantageously in communication with the suction side of the power-unit by a connecting line in which the control valve is located. To supply the control device with hydraulic fluid from the hydraulic accumulator, a hydraulic line is connected to the connecting line between the control valve and the suction side of the power-unit. By means of a connection of this type which supplies the control device with hydraulic fluid from the hydraulic accumulator, it becomes possible in a simple manner with a corresponding actuation of the control valve into an open position for the operation of the power-unit as a motor during a startup of the internal combustion engine, to also supply the control device of the variable displacement volume control device of the power-unit with hydraulic fluid to achieve an adjustment of the displacement volume control device of the power-unit toward the maximum displacement volume.

The hydraulic line is particularly advantageously connected to a control pressure line that runs from the charging pressure circuit to the control device. The shutoff valve is located in the control pressure line. The hydraulic line is connected to the control pressure line between the shutoff valve and the control device. With the connection of the hydraulic line to the control pressure line equipped with the shut off valve, it is possible in a simple manner during a startup of the internal combustion engine to supply only the control device of the power-unit with hydraulic fluid from the hydraulic accumulator.

A pressure reducer valve is advantageously located in the hydraulic line, with which, with little additional construction effort or expense, the pressure level in the hydraulic accumulator can be reduced to the level of the charge pressure for the supply of the control device of the power-unit.

The charge pressure of a charging pressure circuit is particularly advantageously the actuation pressure of the actuator device of the check valve. Consequently, it becomes possible, in a simple manner and with little added construction effort or expense, to achieve a hydrostatic actuation of the actuator device and, thus, of the check valve.

For this purpose, there is advantageously a branch line that runs from the hydraulic line to the actuator device. Between the pressure reducer valve and the connection of the branch line, there is a shutoff valve, in particular a check valve, that shuts off the flow to the pressure reducer valve. With a branch line that branches off from the hydraulic line, during the start-up process, the charge pressure generated via the pressure reducer valve is present in the branch line. After the start-up process, when the internal combustion engine is running, the charge pressure of the charging pressure circuit can pressurize the actuator device to actuate the check valve into the open position and to hold it in the open position to allow operation as a pump.

In one embodiment of the invention, the piston pressure chamber of the positioning piston is in communication with the charging pressure circuit and the spring-side piston pressure chamber of the positioning piston is depressurized to the tank. With a connection of the positioning piston of this type, it is possible, without additional control valves and control logic, to provide operational functionality of the check valve for use of the power-unit as a motor to be a hydraulic starter of the internal combustion engine. The check valve, with the internal combustion engine shut off, is actuated by the spring device into the closed position. When the internal combustion engine is running, the check valve is actuated by the charge pressure generated by the charging pressure circuit into the open position.

In an alternative embodiment of the invention, the control pressure surface of the check valve is in communication with the charging pressure circuit. An additional control pressure surface is formed on the check valve, which actuates the check valve toward the closed position. For pressurization, the additional control pressure surface can be connected with the suction side between the power-unit and the check valve. With control pressure surfaces of this type on the check valve, it becomes possible, without additional control valves and control logic, to achieve functional operation of the check valve for use of the power-unit as a motor, i.e., as a hydraulic starter for the internal combustion engine. The check valve, with the internal combustion engine shut off, is actuated by the spring device into the closed position. When the internal combustion engine is running, the check valve is actuated into the open position by the charge pressure generated by the charging pressure circuit. With the additional control pressure surface, it is guaranteed that the check valve, in the closed position, is held in the closed position during startup of the internal combustion engine by the pressure of the hydraulic accumulator present at the suction side of the power-unit.

In one preferred embodiment of the invention, to control the pressurization of the actuator device, a switching valve is provided. In a first switched position, the check valve can be actuated into the open position as a function of the actuation pressure and, in a second switched position, the check valve can be actuated into the closed position. In the first switched position of the switching valve, the functionality of the switch valve is therefore achieved for the use of the power-unit (operated as a motor) as a hydraulic starter for the internal combustion engine. In the second switched position of the switching valve, when the internal combustion engine is running, the check valve can be actuated into the closed position to achieve a functionality of the check valve for use of the power-unit (operating as a motor) as a booster drive for the running internal combustion engine.

When the actuator device is in the form of a positioning piston, in the first switched position of the switching valve, the piston pressure chamber of the positioning piston is pressurized at the actuation pressure, and the spring-side piston pressure chamber is depressurized to the tank. In the second switched position of the switch valve, the spring-side piston pressure chamber of the positioning piston is pressurized with the actuation pressure, and the piston pressure chamber is depressurized to the tank. In the first switched position of the switching valve, the check valve makes it possible to use the power-unit (operating as a motor) as a hydraulic starter for the internal combustion engine. In the second switched position of the switching valve, when the internal combustion engine is running, the check valve can be actuated into the closed position by the charge pressure pressurizing the spring-side piston pressure chamber of the positioning piston, to achieve a functionality of the check valve for use of the power-unit (operated as a motor) as a booster drive for the running internal combustion engine.

When the actuator device is in the form of a control pressure surface, if in the first switched position of the switching valve the control pressure surface of the check valve is pressurized with the actuation pressure, and the additional control pressure surface of the check valve is in communication with the suction side between the power-unit and the check valve, the functionality of the check valve can be achieved in a simple manner for the use of the power-unit (operated as a motor) as a hydraulic starter for the internal combustion engine.

In one embodiment of the invention, in the second switched position of the switching valve, the control pressure surface and the additional control pressure surface of the check valve are pressurized with the actuation pressure. In the second switched position of the switching valve, it thereby becomes possible, when the internal combustion engine is running, to actuate the check valve by the spring device into the closed position, so that the functionality of the check valve can be achieved for use of the power-unit (operated as a motor) as a booster drive for the running internal combustion engine.

In an alternative embodiment of the invention, in the second switched position of the switching valve, the control pressure surface is depressurized to a tank and the additional control pressure surface is pressurized with the actuation pressure. In the second switched position of the switching valve, it thereby becomes possible, when the internal combustion engine is running, to actuate the check valve into the closed position by the charge pressure present at the other control pressure surface, so that the functionality of the check valve for use of the power-unit (operating as a motor) as a booster drive can be easily achieved when the internal combustion engine is running.

For this purpose, in the closed position of the check valve, there is advantageously a connection of the suction side with the tank in the direction of flow from the tank to the suction side, in particular by means of a check valve, so that the power-unit (operating as a booster drive) can continue to suck hydraulic fluid from the tank with the suction side.

It is advantageous in terms of a simple construction if the control valve and/or the pressure reducer valve and/or the switching valve is/are located in the housing of the check valve.

The control valve and/or the switching valve are advantageously actuated electrically and are in an operative connection with an electronic control device for actuation.

If the electronic control device is in communication with a sensor device that measures the speed of rotation of the internal combustion engine and/or the pressure of the hydraulic accumulator, it is easily possible, by means of appropriate operating strategies stored in the control device, to control the operation of the power-unit as a motor to function as a hydraulic starter of the internal combustion engine and/or as a booster drive of the internal combustion engine by a corresponding actuation of the switched valve and of the switching valve.

The invention further relates to a hydrostatic drive system with a hydrostatic power-unit of the invention in a drive connection with an internal combustion engine. The hydrostatic power-unit can be operated as a pump and as a motor in the same direction of rotation. When operated as a pump, the power-unit supplies at least one user, in particular a working hydraulics system, and, when operated as a motor, functions as a hydraulic starter for a start-stop function of the internal combustion engine and/or as a hydraulic booster drive when the internal combustion engine is running. With the check valve device of the invention, in a drive system with a power-unit used as a hydraulic work pump, the power-unit can be operated as a motor driven by hydraulic fluid from a hydraulic accumulator in a simple manner and without reducing the suction limit speed in pump operation. When operated as a motor, the power-unit is supplied with hydraulic fluid from a hydraulic accumulator, so that a start-stop function and/or a booster drive can be achieved in a low-loss, robust, economical, and structurally simple manner using the hydraulic work pump, which is already present in the drivetrain.

For this purpose, for the start-stop function of the internal combustion engine, when the internal combustion engine is shut off, the check valve is advantageously actuated by the spring device into the closed position. After startup of the internal combustion engine by operating the hydrostatic power-unit as a motor, the check valve can be actuated into the open position by the hydraulic actuation pressure generated at the actuator device when the internal combustion engine is running. For the use of the power-unit as a hydraulic starter of the internal combustion engine, it is therefore possible in a simple manner for the check valve to be in the closed position and, thus, there is no actuation pressure when the internal combustion engine is shut off. The power-unit can be immediately operated as a motor by means of the control valve to start the internal combustion engine without having to first move the check valve into the closed position. After successfully completed startup of the internal combustion engine, in which case the actuation pressure is already achieved during the starting process, the check valve is automatically actuated into the open position so that the users of the working hydraulics can be supplied with hydraulic fluid by operating the power-unit as a pump.

To provide the booster drive when the internal combustion engine is running, the check valve can advantageously be actuated into the closed position by the hydraulic actuation pressure for the duration of operation of the booster drive.

The invention further relates to a vehicle, in particular a mobile machine with a hydrostatic drive system of the invention. On a vehicle with a hydraulic work pump already present, the check valve device of the invention allows for a start-stop function and/or a booster drive of the internal combustion engine to be easily achieved using the existing hydraulic work pump.

### BRIEF DESCRIPTION OF THE DRAWINGS

Additional advantages and details of the invention are explained below with reference to the exemplary embodiments illustrated in the accompanying schematic figures, in which like reference numbers identify like parts throughout.

FIG. 1 shows a first embodiment of the invention;

FIG. 2 shows a second embodiment of the invention;

FIG. 3 shows a third embodiment of the invention;

FIG. 4 shows a development of the invention illustrated in FIG. 1;

FIG. 5 shows a development of the invention illustrated in FIG. 3; and

FIG. 6 shows an additional development of the invention illustrated in FIG. 3.

### DESCRIPTION OF THE PREFERRED EMBODIMENTS

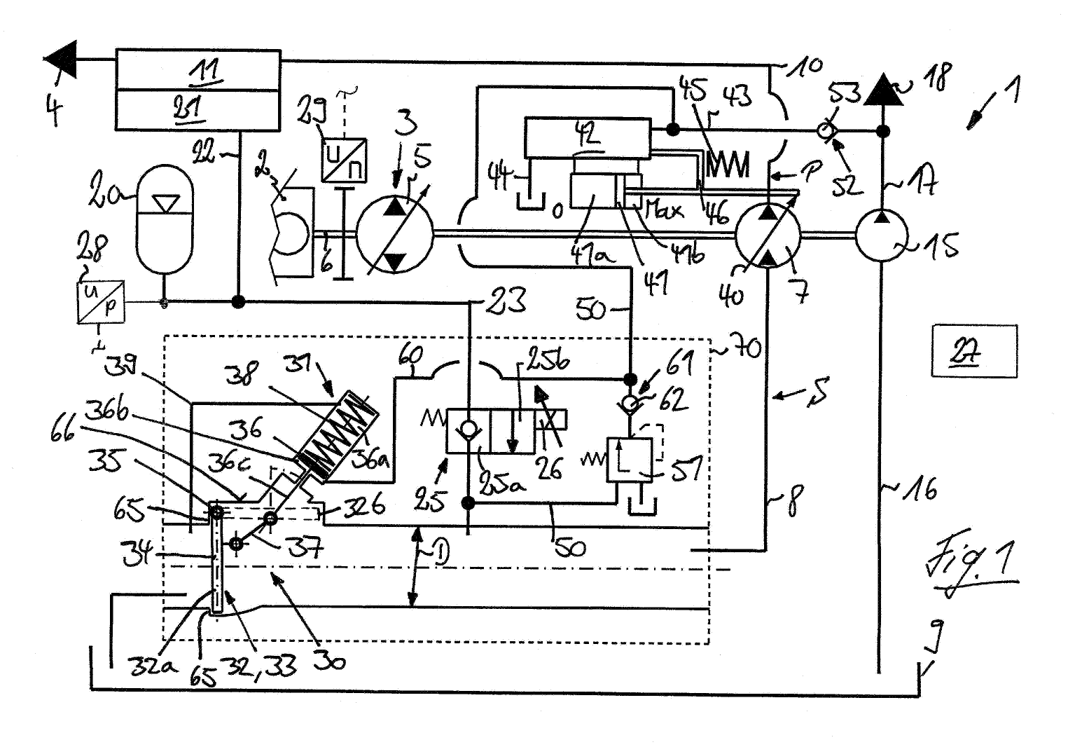

FIG. 1 is a schematic circuit diagram of a hydrostatic drive system 1 of the invention in the drivetrain of a vehicle, for example, a mobile machine in the form of an industrial truck or construction or agricultural equipment.

The drive system 1 of the invention comprises an internal combustion engine 2, such as a diesel engine, a traction drive 3 driven by the internal combustion engine 2, and working hydraulics 4 driven by the internal combustion engine 2.

In the illustrated exemplary embodiment, the traction drive 3 is a hydrostatic traction drive, which includes a continuously variable displacement traction pump 5 as the primary unit. The traction pump 5 is in a drive connection to drive an output shaft 6 of the internal combustion engine 2. The traction pump 5 is in communication with one or more fixed displacement or variable displacement hydraulic motors (not illustrated in further detail) as secondary units in a closed circuit, which secondary units are in an operative connection with the driven wheels of the vehicle in a manner not illustrated in any further detail.

Alternatively, the traction drive 3 can be an electric traction drive with an electric generator driven by the internal combustion engine 2 as the primary unit and one or more electrical traction motors as secondary units. In addition, the traction drive 3 can be a mechanical traction drive with a mechanical transmission, such as a continuously variable transmission or a power split transmission or a torque converter transmission, for example.

The working hydraulics 4 comprise the work functions of the machine, such as, on an industrial truck, for example, the working hydraulics 4 to actuate load holding means on a lifting mast or, on construction equipment in the form of an excavator or a wheeled loader, the work functions of the working equipment can be in the form of a shovel.

To supply the work functions (and therefore the users) with hydraulic fluid, the working hydraulics system 4 comprises a hydrostatic power-unit 7. The power-unit 7 is operated in an open circuit and is in a drive connection with the output shaft 6 of the internal combustion engine 2.

The power-unit 7 can be a constant displacement power-unit with a constant displacement volume. In the illustrated exemplary embodiment, the power-unit 7 is a variable displacement power-unit with a continuously variable displacement volume, for example an axial piston machine utilizing a swashplate construction.

The power-unit 7 is operated in an open circuit and is in communication on the input side with a tank 9 by means of the suction connection and a suction line or a suction channel 8, which form a suction side S. A delivery line 10 is in communication on the output side with the delivery connection and a delivery side P of the power-unit 7 and is connected to a control valve device 11, by means of which the hydraulic users (which are not illustrated in detail) of the working hydraulics 4 can be controlled. The control valve device 11 preferably comprises one or more directional control valves for the actuation of the users, which users can also include a hydraulic steering device of the vehicle.

The drive system 1 further comprises a charge pump 15 driven by a connection with the output shaft 6. In the illustrated exemplary embodiment, the charge pump 15 is a constant displacement pump with a constant displacement volume and is operated in an open circuit. The charge pump 15 is in communication on the suction side with the tank 9 by a suction line 16 and delivers into a charge pressure line 17 connected to the delivery side, to which the corresponding users of a charging pressure circuit 18 are connected, such as, control devices to vary the displacement volume of the traction pump 5 and of the power-unit 7, a feed device for the hydrostatic traction drive 3, a brake system of the vehicle, and pilot valves for the control valves of the working hydraulics 4. When the internal combustion engine 2 is running, the charge pump 15 generates a constant charge pressure in the charging pressure circuit 18. To ensure the constant charge pressure in the charging pressure circuit 18, the charge pressure line 17 is associated with a pressure limiting device, such as a pressure limiting valve.

On the drive train 1 of the invention, the hydrostatic power-unit 7 of the working hydraulics 4 is a two-quadrant power-unit, which can be operated as a pump and as a motor in the same direction of rotation and the same direction of flow of the hydraulic fluid.

When operated as a pump, in which case the power-unit 7 is driven by the running internal combustion engine 2, the power-unit 7 sucks hydraulic fluid via the suction line 8 from the tank 9 and delivers the hydraulic fluid into the delivery line 10 to supply the users of the working hydraulics 4. The power-unit 7, when operated as a pump, also charges a hydraulic accumulator 20, which can be connected to the delivery line 10 by a charge valve 21 and a charge line 22. To charge the hydraulic accumulator 20, the power-unit 7 operating as a pump can optionally be driven with the kinetic energy absorbed from the vehicle, which increases as the vehicle decelerates, or it can also be driven on the primary side by the running internal combustion engine 2.

When the power-unit 7 is operated as a motor, in which the power-unit 7 acts as a hydraulic starter to provide a start-stop function to start the internal combustion engine 2, the power-unit 7 is driven on the suction side S with hydraulic fluid from the hydraulic accumulator 20.

The connection of the hydraulic accumulator 20 with the suction side S of the power-unit 7 for the operation of the power-unit 7 as a motor can be controlled by an electrically actuated control valve 25. The control valve 25 has a closed position 25a and an open position 25b. The closed position 25a is preferably leak-tight, with a shutoff valve that shuts off the flow to the power-unit 7. The control valve 25 is an electrically actuated control valve, preferably a switching valve, which can be actuated between the closed position 25a and the open position 25b by an electrical actuator device 26, such as a switch magnet.

For its actuation, the actuator device 26 is in communication with an electronic control device 27. To monitor the accumulator charge pressure and, thus, the accumulator status of the hydraulic accumulator 20, there is a pressure sensor device 28 which is in communication with the control device 27. The electronic control device 27 is also in communication with a speed sensor device 29 that measures the speed of rotation of the internal combustion engine 2. The control device 27 can also actuate the charge valve 21 for charging the hydraulic accumulator 20.

The control valve 25 is located in a connecting line 23 that runs from the hydraulic accumulator 20 to the suction line 8 and is connected to the suction line 8.

A check valve device 30 of the invention is located in the suction line 8 of the power-unit 7, between the connection of the connecting line 23 and the tank 9. When the power-unit 7 is operated as a motor, the check valve device 30 makes possible a pressure increase on the suction side S. The check valve device 30 has a check valve 32 that can be actuated by an actuator device 31. By means of the actuator device 31, the check valve 32 can be actively switched between a closed position 32a (illustrated in FIG. 1) in which the communication between the suction side S and the tank 9 in the direction of flow from the suction side S to the tank 9 is shut off, and an open position 32b (illustrated in broken lines in FIG. 1) in which the communication between the suction side S and the tank 9 is opened.

To adjust the displacement volume, the power-unit 7, which in the illustrated exemplary embodiment is in the form of a variable displacement power-unit with a continuously variable displacement volume, has a displacement volume control device 40, such as a variable-inclination swashplate of an axial piston machine utilizing a swashplate construction. For actuation, the displacement volume control device 40 has a positioning piston device 41 in an operative connection with the displacement volume control device 40. The power-unit 7 is a unilaterally variable power-unit in which the displacement volume control device 40, beginning from a position with a minimum displacement volume, can be adjusted in a control position or pivoting direction into a position with maximum displacement volume. The positioning piston device 41 has a control pressure compartment 41a that acts in the direction of the maximum displacement volume and a control pressure compartment 41b which acts in the direction of the minimum displacement volume.

The displacement volume control device 40 can be actuated by a control device 42. The control device 42 has a control valve (not illustrated in detail), by means of which the pressurization of the control pressure compartments 41a, 41b can be controlled with a control pressure or by their depressurization to the tank 9.

To supply hydraulic fluid and to generate a control pressure in the control pressure chambers 41a and 41b, the control device 42 is in communication via a control pressure line 43 with the charge pressure line 17 and, thus, with the charging pressure circuit 18. The control device 42 also has a connection to a tank line 44 that leads to the tank 9. The control device 42 is preferably actuated electrically and for this purpose is in communication with the electronic control device 27. In the illustrated exemplary embodiment, the control device 44 comprises a control valve, with a mechanical feedback 46 of the current position of the displacement volume control device 40 to the control device 42. There is also a spring device 45 in the form of a compression spring which acts on the displacement volume control device 40 in the direction of the minimum displacement volume. The spring device can be limited by a corresponding stop on the displacement volume control device 40.

To pressurize the displacement volume control device 40 into the position with maximum displacement volume during a startup of the shut-off internal combustion engine 2 by operating the power-unit 7 as a motor, the control device 42 can also be connected to the hydraulic accumulator 20 to supply hydraulic fluid and, thus, to generate a control pressure. For this purpose, a hydraulic line 50 is provided that runs from the control pressure line 43 to the connecting line 23. A pressure reducer valve 51 is located in the hydraulic line 50. The hydraulic line 50 is connected to the connecting line 23 between the control valve 25 and the suction line 8.

A shutoff valve 52 is also located in the connection between the control device 42 and the charging pressure circuit 18. The hydraulic line 50 is connected to the control pressure line 43 between the shutoff valve 52 and the control device 42. In the illustrated exemplary embodiment, the shutoff valve 52 is a check valve 53 that opens to allow flow to the control device 42.

In FIG. 1, the check valve 32 of the invention located in the suction line 8 is a flapper valve 33 with a flapper 34 that can pivot around a pivoting axis 35. The flapper 34 is in an operative connection for actuation with the actuator device 31.

The actuator device 31 of the check valve 32 of the invention is a longitudinally displaceable positioning piston 36. The positioning piston 36 has a piston rod 36c in a drive connection with the flapper 34. In FIG. 1, the piston rod 36c of the positioning piston 36 is in operative connection with the flapper 34 via the interposition of a tie rod 37, such as a swing arm, which is connected in an articulated manner to the flapper 34 and in an articulated manner to the piston rod 36c of the positioning piston 36.

The positioning piston 36 is located so that it can move longitudinally in a cylinder housing, in which there is a piston pressure chamber 36a that pressurizes the positioning piston 36 toward the illustrated closed position 32a of the check valve 32 and a piston pressure chamber 36b that pressurizes the positioning piston 36 into the opening position 32b of the check valve 32. There is a spring device 38, such as a compression spring, in the piston pressure chamber 36a that acts on the positioning piston 36 and, thus, actuates the check valve 32 into the closed position 32a. The piston pressure chamber 36a provided with the spring device 38 is connected with the tank 9 by a depressurization line 39.

The check valve 32 of the invention can be actuated into the open position 32b by a hydraulic actuation pressure which pressurizes the actuator device 31. In the illustrated exemplary embodiment, the actuation pressure is formed by the constant charge pressure of the charging pressure circuit 18, for which purpose a branch line 60 that branches off the hydraulic line 50 or the control pressure line 43 is connected to the piston pressure chamber 36b of the positioning piston 36 that acts in the opening direction. Between the pressure reducer valve 51 located in the hydraulic line 50 and the connection of the branch line 60, there is a shut-off valve 61 which, in the illustrated exemplary embodiment, is a check valve 62 that shuts off the flow to the pressure reducer valve 51.

The flapper 34 of the flapper valve 33, in the illustrated closed position 32a, actuates a valve seat 65 in the suction line 8 which, for this purpose, is a suction channel, at least in the vicinity of the valve seat 65.

The pivoting axis 35 of the flapper 34 is oriented in the radial direction outside a diameter D of the suction line 8 so that in the open position 32b (and, thus, the open switched position), the flapper 34 does not protrude into the suction line 8 and, in the open position 32b, does not cause any additional hydraulic resistance and, thus, flow resistance in the suction line 8. For this purpose, there is a radial expansion 66 in the suction line 8 in the form of a suction channel, into which the flapper 34 preferably pivots all the way in the open position 32b.

The check valve device 30 of the invention can be installed in the housing of the power-unit 7. In the illustrated exemplary embodiment, the check valve device 30 has a separate housing 70 which forms a section of the suction line 8. The control valve 25 and the pressure reducer valve 51 can also be installed in the housing 70 (indicated by the broken line in FIG. 1) of the check valve device 30. The housing 70 can preferably be connected and attached by a flange to the suction connection of the power-unit 7. Alternatively, this housing 70 can be installed separately from the power-unit 7 in any desired location in the suction line 8 inside the vehicle.

The drive system 1 in FIG. 1, in which the power-unit 7 operated as a motor can be used as a hydraulic starter of the internal combustion engine 2 for a start-stop function, works as follows.

With the internal combustion engine 2 shut off and the charge pump 15 not being driven, and with the control valve 25 in the closed position 25a, the charge pressure present in the control pressure line 43 and the hydraulic line 50 connected to it (and, thus, the actuation pressure of the positioning piston 36 present in the piston pressure chamber 36b) drops so that the flapper 34 is actuated by the positioning piston 36, which is pushed by the spring device 38 in the closing direction into the closed position 32a illustrated in FIG. 1. As a result of the drop in the charge pressure when the internal combustion engine 2 is shut off, the power-unit 7 is set to the position with the minimum displacement volume. In the closed position 32a, the flapper 34 is held against the valve seat 65 by the spring device 38 with a defined force. In the closed position 32a, the connection between the suction side S of the power-unit 7 in the direction of flow to the tank 9 is cut off. For the startup of the internal combustion engine 2, the control valve 25 (when the hydraulic accumulator is charged) is actuated into the open position 25b. Thus, the suction line 8 is pressurized with the pressure and hydraulic fluid of the hydraulic accumulator 20 for the operation of the power-unit 7 as a motor. In the open position 25b of the control valve 25, the control device 42 of the power-unit 7 is supplied with the charge pressure by the pressure reducer valve 51 so that the power-unit 7 can be set in the direction of the maximum displacement volume. The shutoff valve 52 in the control pressure line 43 ensures that, during a startup process of the internal combustion engine 2, only the control device 42 of the power-unit 7 is supplied with a charge pressure from the hydraulic accumulator 20 via the pressure reducer valve 51 and prevents the charge pressure generated from the hydraulic accumulator 20 from being supplied to the other users of the charging pressure circuit 18 during the startup process. Once the torque resulting from the displacement volume and the pressure present in the suction side S of the power-unit 7 overcome the torque resulting from the adhesive friction of the output shaft 6 and the units connected to it, the startup of the internal combustion engine 2 takes place.

By means of the branch line 60, the charge pressure generated at the pressure reducer valve 51 is present in the piston pressure chamber 36b of the positioning piston 36 and generates a force on the positioning piston 36 acting in the direction of the open position of the flapper 34. However, the force acting from the pressure of the hydraulic accumulator 20 (and, thus, the pressure in the suction line) on the flapper 34 toward the closed position 32a is greater than the opening force on the positioning piston 36, so that the flapper 34 is held in the closed position 32a during the startup process of the engine 2 and the operation of the power-unit 7 as a motor.

If a speed of rotation that indicates a successful startup process is detected by the speed sensor 29, the control valve 25 is actuated into the closed position 25a and the operation of the power-unit 7 as a motor is ended. Consequently, the pressure of the hydraulic accumulator 20 acting on the flapper 34 in the closing direction drops. With the startup process of the internal combustion engine 2, a constant charge pressure is built up in the control pressure line 43 via the driven charge pump 15 and is present in the piston pressure chamber 36b of the positioning piston 36 via the hydraulic line 50 and the branch line 60, so that the flapper 34 can be actuated by the positioning piston 36 into the open position 32b.

When the flapper 34 is in the open position 32b, the power-unit 7 driven by the internal combustion engine 2 can be used as a pump to supply the users of the working hydraulics 4. The flapper 34 in the open position 32b in the suction line 8 does not cause any additional hydraulic resistance or flow resistance, which reduces the suction limit speed of the power-unit 7 when operated as a pump.

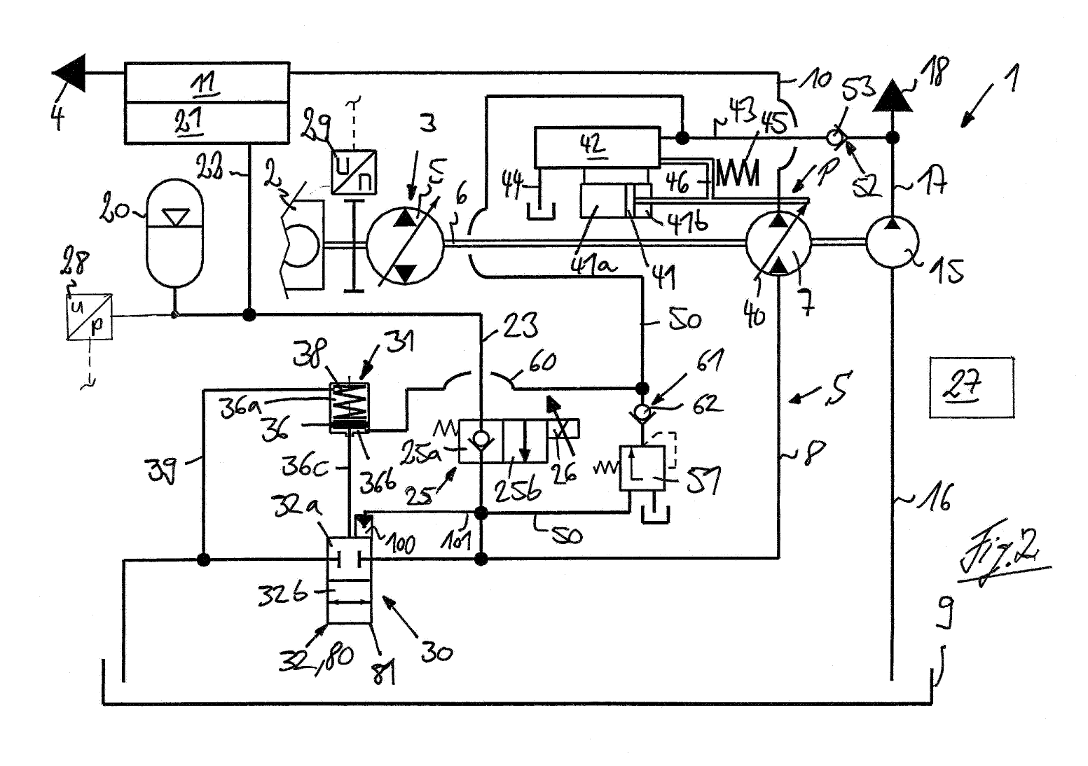

FIG. 2 shows a second exemplary embodiment of the invention. Identical components are identified by the same reference numbers.

FIG. 2 differs from FIG. 1 with regard to the construction of the check valve 32 of the invention. The check valve 32 in FIG. 2 is a piston or flat slide valve 80 with a longitudinally displaceable piston or slide 81, which for actuation is in an operative connection with the actuator device 31 (which is analogous to the one illustrated in FIG. 1). The piston or slide 81 can be actuated into the open position 32b by the actuator device 31 by the actuator pressure (in the form of the charge pressure) and can be actuated into the closed position 32a by the spring device 38 when the internal combustion engine 2 is shut off.

To hold the check valve 32 (e.g., a piston or flat slide valve 80) in the closed position 32a for the duration of the startup process of the internal combustion engine 2 and to prevent the actuation of the check valve 32 before the end of the startup process of the internal combustion engine 2 by the charge pressure generated in the branch line 60 against the force of the spring device 38 into the open position 32b, there is an additional control pressure surface 100 on the check valve 32 that acts in the direction of the closed position 32a, which during a startup of the internal combustion engine 2 is pressurized by the pressure of the hydraulic accumulator 20 and, thus, the pressure in the suction line 8. For this purpose, there is a control pressure line 101 which is in communication with the control pressure surface 100, which in the illustrated exemplary embodiment is connected to the connecting line 23 between the control valve 25 in the suction line 8.

The piston or slide 81 is located in the suction line 8 such that, in the open position 32b, it presents no additional flow resistance in the suction side S for the hydraulic fluid sucked in by the power-unit 7 operating as a pump.

As an alternative to a construction of the check valve 32 as a flat slide valve 80, the check valve 32 in FIG. 2 can be a piston slide valve with a longitudinally displaceable (and preferably cylindrical) piston, which for actuation is in an operative connection with the actuator device 31. The check valve can also be in the form of a ball valve.

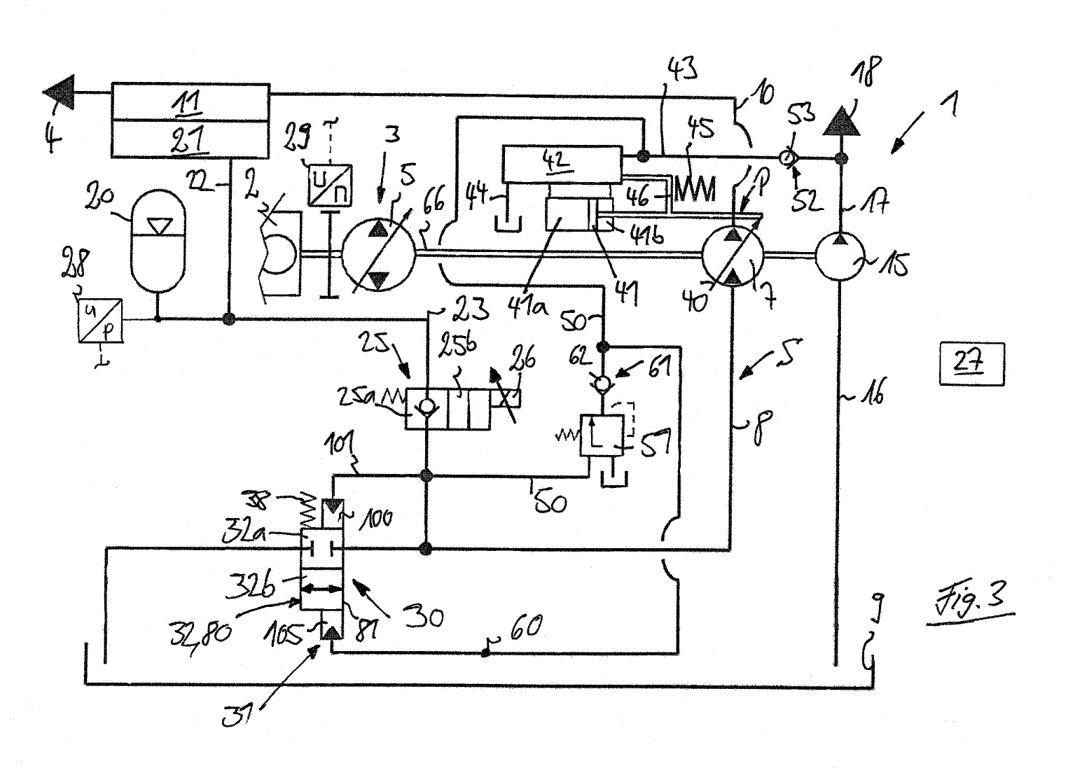

FIG. 3 illustrates a third exemplary embodiment of the invention. The same components are identified by the same reference numbers.

In FIG. 3, the check valve 32 is a piston or flat slide valve 80 with a longitudinally displaceable piston or slide 81 which, for actuation, is in an operative connection with the actuator device 31, which is in the form of a control pressure surface 105 on the check valve 32 that acts in the direction of the open position 32b. For pressurization of the control pressure surface 105 with the actuation pressure, the control pressure surface 105 is connected with the branch line 60. The check valve 32 is pressurized toward the closed position 32a by the spring device 38. Also provided on the check valve 32 is the additional control pressure surface 100 that act in the direction of the closed position 32a. The control pressure surface 100 is in communication with the control pressure line 101 to hold the check valve 32 in the closed position 32a during the startup of the internal combustion engine 2 by the pressure of the hydraulic accumulator 20 and, thus, the pressure in the suction line 8 and to prevent the check valve 32 from being actuated into the open position 32b before the end of the startup of the internal combustion engine 2 by the charge pressure generated against the force of the spring device 38.

When the internal combustion engine 2 is shut off and, therefore, when the charge pump 15 is not being driven, and when the control valve 25 is in the closed position 25a, the charge pressure in the control pressure line 43 and the charge pressure in the hydraulic line 50 connected to it drops, which acts on the control pressure surface 105 so that the check valve 32 is pushed by the spring device 38 into the closed position 32a. For startup of the internal combustion engine 2, the control valve 25 is actuated when the hydraulic accumulator 20 is charged with hydraulic fluid into the open position 25b, so that when the check valve 32 is in the closed position 32a, the internal combustion engine 2 can be started by the power-unit 7 operated as a motor.

For the duration of the startup process, the pressure of the hydraulic accumulator 20 and the pressure in the suction line 8 are present at the additional control pressure surface 100. As a result, the check valve 32 is held in the closed position 32a and the opening of the check valve 32 by the charge pressure present on the control pressure surface 105 is prevented.

After the startup of the internal combustion engine 2, the control valve 25 is actuated into the closed position 25a, so that the pressure acting in the closing direction present at the additional control pressure surface 100 from the hydraulic accumulator 20 drops. The charge pressure generated by the driven charge pump 15 is present via the branch line 60 at the control pressure surface 105. As a result, the check valve 32 is actuated into the open position 32b by the actuator device 31, which is a control pressure surface 105.

In the exemplary embodiments illustrated in FIGS. 1 and 2, the spring-side piston pressure chamber 36a of the positioning piston 36 that acts in the closing direction 32a is depressurized to the tank 9 via the depressurization line 39. The piston pressure chamber 36b of the positioning piston 36, which acts in the opening direction 32b, can be pressurized via the branch line 60 with the actuation pressure (charge pressure), so that the operation of the power-unit 7 as a motor makes it possible for the power-unit 7 to act as a hydraulic starter for a start-stop function of the shut-off internal combustion engine 2.

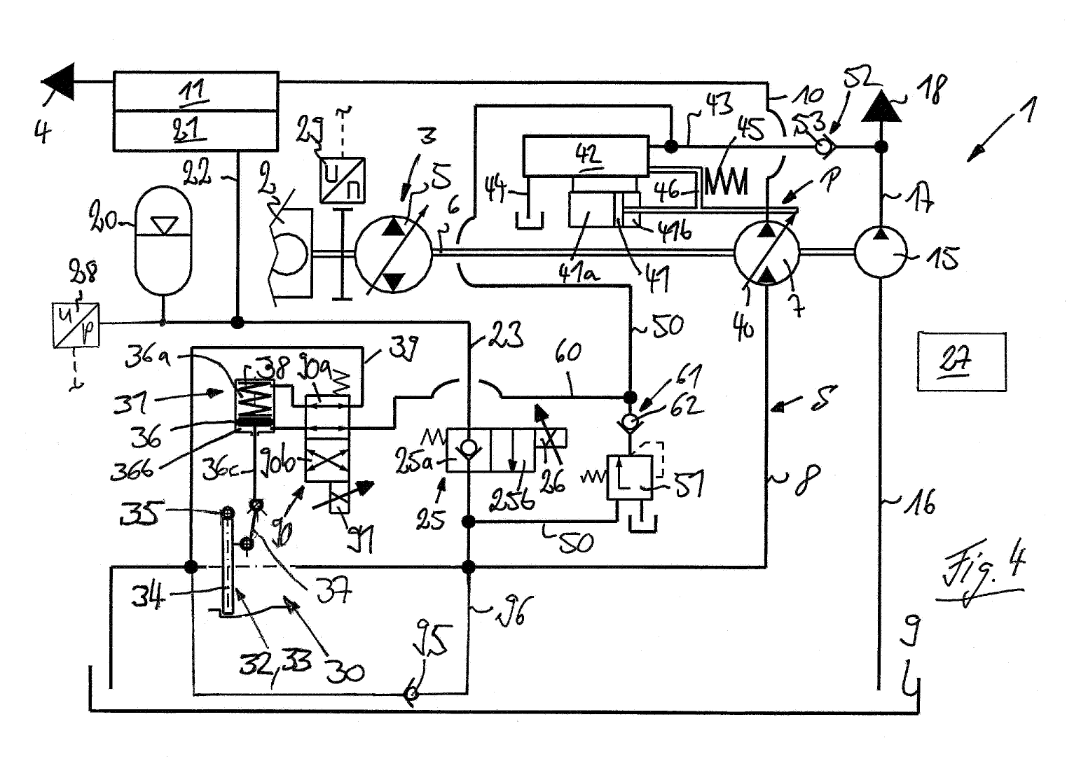

FIG. 4 illustrates a development of FIG. 1, in which identical components are identified by the same reference numbers. In FIG. 4, to control the pressurization of the actuator device 31, a switching valve 90 is provided, by means of which, in a first switched position 90a, the check valve 32 can be actuated as a function of the actuation pressure into the open position 32b, and by means of which, in a second switched position 90b, the check valve 32 can be actuated into the closed position 32a. For this purpose in FIG. 4, to control the pressurization of the piston pressure chambers 36a, 36b of the positioning piston 36, there is a switching valve 90, by means of which the piston pressure chamber 36b of the positioning piston 36, which in a first switched position 90a acts in the opening direction 32b, is pressurized with the actuator pressure and the spring-side piston pressure chamber 36a, which acts in the closed position 32b, is depressurized to the tank 9. In a second switched position 90b, the spring-side piston pressure chamber 36a of the positioning system 36, which acts in the direction of the closing position 32a, is pressurized with the actuation pressure and the piston pressure chamber 36b, which acts in the direction of the open position 32b, is depressurized to the tank 9.

For this purpose, the switching valve 90 is in communication with the branch line 60 that carries the actuation pressure, the depressurization line 39, and the two piston pressure chambers 36a, 36b of the positioning piston 36. The switching valve 90 is a four-connection, two-position valve.

The switching valve 90 is an electrically actuated control valve, preferably a switching valve, which can be actuated between the switched positions 90a, 90b by the electrical actuator device 91, such as a switching magnet. For actuation, the switching valve 90 is operatively connected with the electronic control device 27.

If a separate housing 70 is provided for the check valve device 30 illustrated in FIG. 1, the switching valve 90 is preferably installed in the housing 70.

In the switched position 90a of the switching valve 90, the result is the actuation of the check valve 32 described above and illustrated in FIG. 1 that allows the power-unit 7 operating as a motor to act as a hydraulic starter to provide a start-stop function of the internal combustion engine 2.

The switched position 90b of the switching valve 90 makes possible the reverse actuation of the check valve 32, so that by operating the hydrostatic power-unit 7 as a motor when the internal combustion engine 2 is running, an additional torque can be delivered to the output shaft 6 of the internal combustion engine 2, thereby creating a booster drive. With the booster drive provided by the hydrostatic power-unit 7, the internal combustion engine 2 can be boosted during traction operation of the vehicle.

For the booster drive, the switching valve 90 is actuated into the switched position 90b, so that the charge pressure generated by the driven charge pump when the internal combustion engine 2 is running is present via the control pressure line 43, the hydraulic line 50, and the branch line 60, in the spring-side piston pressure chamber 36a of the positioning piston 36, which acts in the direction of the closed position 32a of the check valve 32. Because in the switched position 90b of the switching valve 90 the piston pressure chamber 36b of the positioning piston 36, which acts in the opening direction 32b, is depressurized to the tank 9, when the internal combustion engine 2 is running, the check valve 32 is actuated into the closed position 32a to shut off the connection of the suction line 8 in the flow direction to the tank 9. By actuating the control valve 25 into the flow position 25b, the power-unit 7 can be operated as a motor with hydraulic fluid under pressure from the hydraulic accumulator 20 to feed a torque to the drivetrain to assist the running internal combustion engine 2.

In FIG. 4, in the closed position 32a of the check valve 32, a connection is made possible between the suction side S and the tank 9 in the direction of flow from the tank 9 to the suction side S when the booster drive is in operation, for which purpose there is a check valve 95 that opens toward the power-unit 7 in a bypass line 96 of the suction line S which bypasses the check valve 32. The check valve 95 makes it possible for the booster drive to suck hydraulic fluid from the tank 9 by the power-unit 7 driven by the running internal combustion engine 2 when the check valve 32 is in the closed position 32b before the opening of the control valve 25 into the open position 25b for operation of the power-unit 7 as a motor.

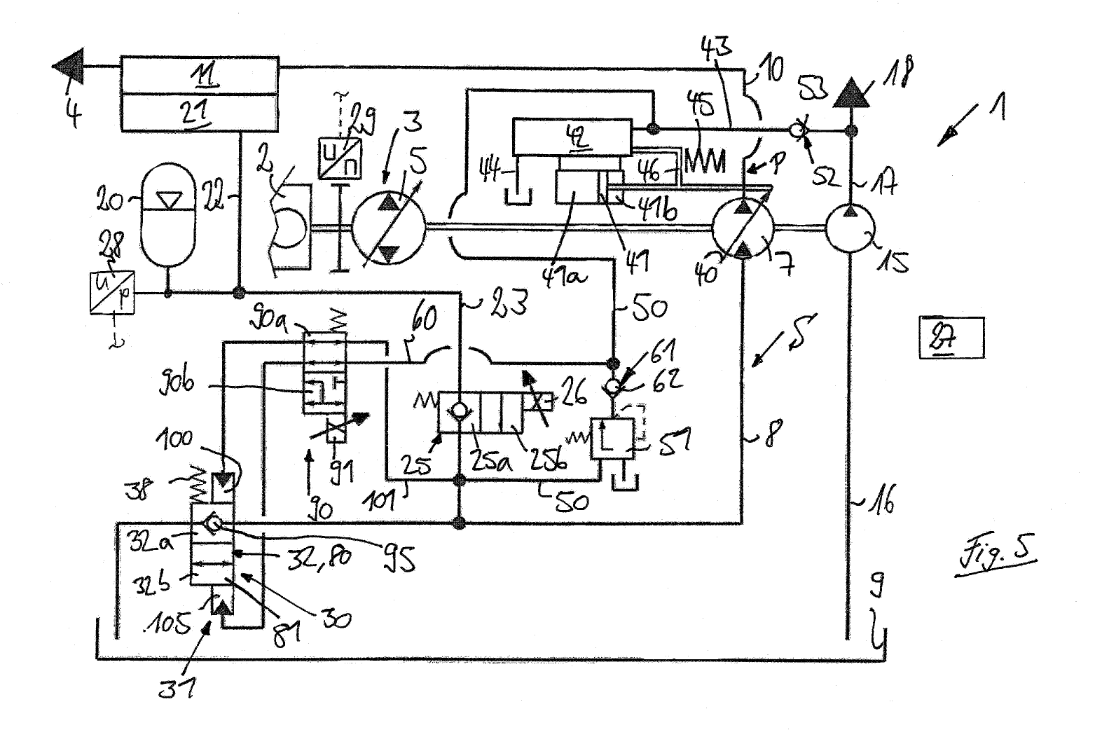

FIG. 5 illustrates a development of FIG. 3, with which the switching valve 90 makes it possible for the hydrostatic power-unit 7 to function as a booster drive to assist the running internal combustion engine 2.

The switching valve 90 is in communication with the branch line 60 which carries the actuation pressure, the control pressure line 101 connected to the connecting line 23, and the two control pressure surfaces 100, 105. The switching valve 90 is a four-connection, two-position valve and can be electrically actuated by the electric actuator device 91.

In the first switched position 90a of the switching valve 90, the control pressure surface 105 of the check valve 32 is in communication with the branch line 60 and is pressurized with the actuation pressure. The additional control pressure surface 100 of the check valve 32 is connected in the first switched position 90a to the control pressure line 101 and is, thus, in communication with the suction side S between the power-unit 7 and the check valve 32. In the switched position 90a of the switching valve 90, the result is the actuation of the check valve 32 described above and illustrated in FIG. 3 for use of the power-unit 7, operating as a motor, as a hydraulic starter in a start-stop function of the internal combustion engine 2.

In the second switched position 90b of the switching valve 90, the control pressure surface 105 and the additional control pressure surface 100 of the check valve 32 are connected to the branch line 60 and are, thus, pressurized by the actuation pressure. The control pressure line 101 in the second switched position 90b of the switching valve 90 is shut off. As a result of the actuation of the switching valve 90 into the second switched position 90b, the check valve 32 is, therefore, actuated by the spring device 38 into the closed position 32a.

For the booster drive, the switching valve 90 is actuated into the switched position 90b, in which the check valve 32 is actuated into the closed position 32a and the connection of the suction line 8 in the direction of flow to the tank 9 is shut off. As a result of the actuation of the switching valve 25 into the open position 25b, the power-unit 7 can be driven with hydraulic fluid under pressure from the hydraulic accumulator 20 and operated as a motor to feed a torque into the drivetrain to assist the running internal combustion engine 2.

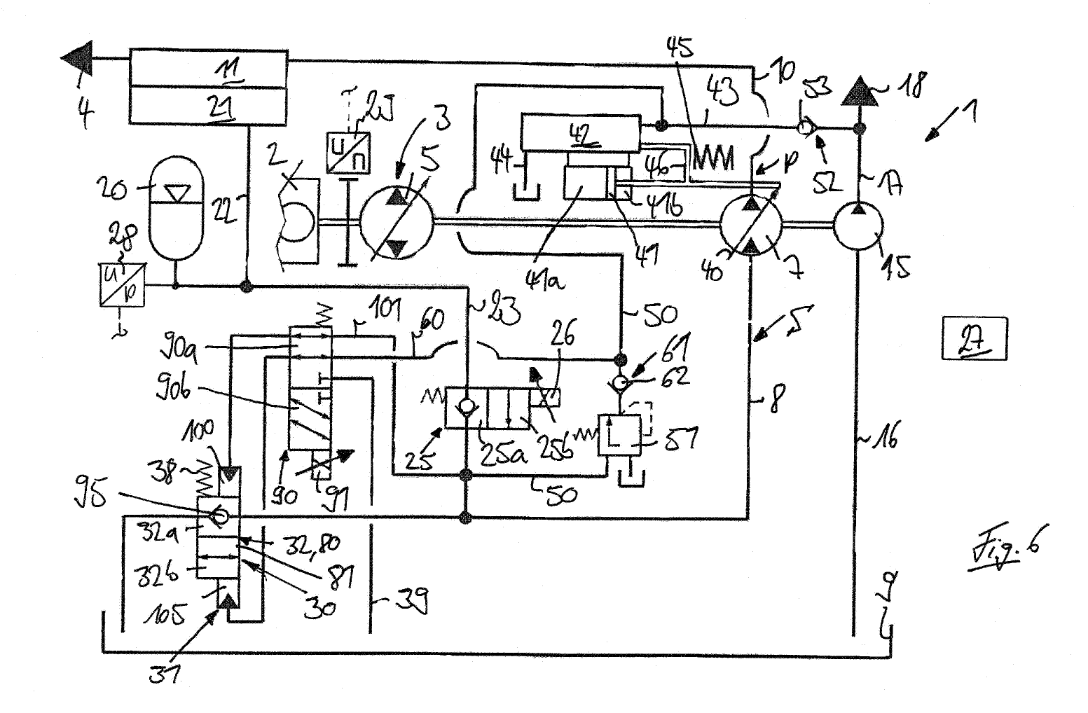

FIG. 6 illustrates an additional development of FIG. 3 which differs from FIG. 5 in the construction of the switching valve 90.

The switching valve 90 in FIG. 6 is a five-connection, two-position valve which can be actuated electrically by the electrical actuator device 91. The switching valve 90 is in communication with the branch line 60 that carries the actuation pressure, the control pressure line 101 connected to the connecting line 23, the two control pressure surfaces 100, 105, and the depressurization line 39 that leads to the tank 9.

In the first switched position 90a of the switching valve 90, the control pressure surface 105 of the check valve 32 is connected with the branch line 60 and is pressurized with the actuation pressure. The additional control pressure surface 100 of the check valve 32 is connected in the first switched position to the control pressure line 101 and is in communication with the suction side S between the power-unit 7 and the check valve 32. The depressurization line 39 is shut off. In the switched position 90a of the switching valve 90, the result is the actuation of the check valve 32 described above and illustrated in FIG. 3 for use of the power-unit 7, operating as a motor, as a hydraulic starter in a start-stop function of the internal combustion engine 2.

In the second switched position 90b of the switching valve 90, the control pressure surface 105 is in communication with the depressurization line 39 and the additional control pressure surface 100 is connected to the branch line 60 and is, thus, pressurized by the actuation pressure. The control pressure line 101 is shut off. As a result of the actuation of the switching valve 90 into the second switched position 90b, the check valve 32 is actuated by the spring device 38 and the charge pressure present at the additional control pressure surface 100 into the closed position 32a.

For the booster drive, the switching valve 90 is actuated into the switched position 90b, in which the check valve 32 is actuated into the closed position 32a and the connection of the suction line 8 in the direction of flow to the tank 9 is shut off. As a result of the actuation of the switched valve 25 into the open position 25b, the power-unit 7 can be driven as a motor with hydraulic fluid under pressure from the hydraulic accumulator 20 to feed a torque into the drivetrain to assist the running internal combustion engine 2.

In FIGS. 5 and 6, in the closed position 32a of the check valve 32, a connection of the suction side S with the tank 9 in the direction of flow from the tank 9 to the suction side S while the booster drive is in operation becomes possible, for which purpose in the closed position 32a, there is a check valve 95 that opens toward the power-unit 7.

The invention has a series of advantages.

The check valve 32 of the invention, which can be actively controlled by the actuator device 31 and can be actuated hydrostatically by the actuation pressure, makes it possible for the existing hydrostatic power-unit (which is used to supply the working hydraulics 4 when operating as a pump) to also be operated as a motor as a hydraulic starter for the internal combustion engine 2 and/or as a booster drive to assist the running internal combustion engine 2, such as during traction operation, without creating additional hydraulic flow resistance in the suction side S in pump operation, which would reduce the suction limit speed during pump operation of the power-unit 7.

The actuator device 31 (positioning piston 36 or control pressure surface 105) is pressurized in the direction of the open position 32b of the check valve 32 by the pressure provided in the form of the charge pressure of the charging pressure circuit 18 supplied by the charge pump 15 or by the actuation pressure in the form of the pressure of the hydraulic accumulator 20 provided via the pressure reducer valve 51, so that when the internal combustion engine 2 is running, the check valve 32 is actuated into the open position 32b. When the internal combustion engine 2 is shut off, and the charge pressure consequently drops, and with the control valve 25 in the closed position 25a, the check valve 32 is actuated by the spring device 38 into the closed position 32a and is held in the closed position 32a by the spring device 38. When the internal combustion engine 2 is shut off, the check valve 32 is automatically in the closed position 32a, so that for a start-stop function by actuation of the control valve 25 into the open position 25b, a hydrostatic start of the internal combustion engine 2 can be achieved immediately and directly by operating the power-unit 7 as a motor without first having to actuate the check valve 32 into the closed position 32a. The function of the check valve 32 in a start-stop function and the use of the power-unit 7 as a hydraulic starter for the internal combustion engine 2 can be achieved without additional control logic and additional control valves for the actuation of the actuator device 31.

With the switching valve 90 illustrated in FIGS. 4-6, and with a check valve device 30 illustrated in FIGS. 1-3, it becomes possible in a simple manner to reverse the function of the actuation of the check valve 32, so that when the internal combustion engine 2 is running, the actuation of the check valve 32 into the closed position 32a by the actuation pressure in the form of a constant charge pressure results in operation of the power-unit 7 as a motor to deliver a torque to the output shaft 6 for a booster drive.

The invention is not restricted to the illustrated exemplary embodiments.

The check valve 32 can be a piston slide valve with a rotating piston or a ball cock with a rotating ball, whereby the piston or the ball is in an operative connection with the actuator device 31 and is actively rotated between a closed position and an open position by the actuator device 31 (e.g., a positioning piston 36 or a control pressure surface 105).

The hydrostatic power-unit 7, as an alternative to the realization in the form of an axial piston machine, can be a geared machine, a radial piston machine, or any other common design, each with a constant displacement volume or, alternatively, a continuously variable displacement volume.

Nor is the invention restricted to the illustrated sequence of the arrangement of the traction drive 3, the hydrostatic power-unit 7, and the charge pump 15 on the output shaft 6 of the internal combustion engine 2, the order and arrangement of which can be varied and modified arbitrarily.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. A check valve device for a hydrostatic power-unit in a drive connection with an internal combustion engine, comprising:
a check valve device located in a suction side of a hydrostatic power-unit operable as a pump and a motor such that when the power-unit is operated as a motor, a pressure increase is provided on the suction side, wherein the check valve device includes a check valve connected to an actuator device, and wherein the actuator device actuates the check valve between a closed position in which a connection of the suction side with a tank in the direction of flow from the suction side to the tank is shut off, and an open position in which the connection of the suction side to the tank is opened.

2. The check valve device as recited in claim 1, wherein the check valve is actuated by the actuator device into the open position when the power-unit is operated as a pump and into the closed position when the power-unit is operated as a motor.

3. The check valve device as recited in claim 1, wherein the check valve is actuated by a spring device into the closed position and the check valve is actuated into the open position by a hydraulic actuation pressure applied to the actuator device.

4. The check valve device as recited in claim 1, wherein in the closed position the check valve is pressurized in the closed position by hydraulic pressure from a hydraulic accumulator connected to the suction side.

5. The check valve device as recited in claim 1, wherein the actuator device comprises a positioning piston connected with the check valve.

6. The check valve device as recited in claim 5, wherein the positioning piston is operatively connected to a spring device and includes a piston pressure chamber pressurized with an actuation pressure that counteracts the spring device.

7. The check valve device as recited in claim 6, wherein the spring device is located in a spring-side piston pressure chamber of the positioning piston connected with the tank.

8. The check valve device as recited in claim 1, wherein the actuator device comprises a control pressure surface located on the check valve and pressurizable by a hydraulic actuation pressure that actuates the check valve in the direction of the open position.

9. The check valve device as recited in claim 1, wherein the check valve comprises a flapper valve with a pivotable flapper in an operative connection with the actuator device.

10. The check valve device as recited in claim 9, wherein the positioning piston is connected with the flapper by a tie rod connected in an articulated manner to the flapper and in an articulated manner to the positioning piston.

11. The check valve device as recited in claim 9, wherein the pivotable flapper is located in a suction channel, and when in the open position the flapper does not protrude into the suction channel.

12. The check valve device as recited in claim 1, wherein the check valve comprises a flat slide valve with a longitudinally displaceable slide operatively connected with the actuator device.

13. The check valve device as recited in claim 1, wherein the check valve comprises a piston slide valve with a longitudinally displaceable or rotatable piston operatively connected with the actuator device.

14. A hydrostatic power-unit, comprising:
a hydrostatic power-unit in a drive connection with an internal combustion engine, wherein the hydrostatic power-unit is operable as a pump and as a motor, wherein in pump operation the power-unit sucks hydraulic fluid via a suction side from a tank and delivers into a delivery side, and wherein in motor operation the power-unit is driven by hydraulic fluid under pressure from a hydraulic accumulator and fed via the suction side; and
a check valve device located in the suction side of the hydrostatic power-unit, wherein the check valve device includes a check valve connected to an actuator device, and wherein the actuator device actuates the check valve between a closed position in which a connection of the suction side with the tank in the direction of flow from the suction side to the tank is shut off, and an open position in which the connection of the suction side to the tank is opened.

15. The hydrostatic power-unit as recited in claim 14, wherein the check valve device includes an independent housing.

16. The hydrostatic power-unit as recited in claim 15, wherein the housing of the check valve device is flange-mounted on a housing of the power-unit.

17. The hydrostatic power-unit as recited in claim 20, including a control valve that controls a connection of the hydraulic accumulator with the suction side of the power-unit for operation as a motor.

18. The hydrostatic power-unit as recited in claim 14, wherein the power-unit is a variable displacement power-unit with a variable displacement volume, wherein the displacement volume is set by a displacement volume control device actuated by a control device, and wherein the control device is connected to a charging pressure circuit and with the hydraulic accumulator for a supply of hydraulic fluid.

19. The hydrostatic power-unit as recited in claim 18, including a shut-off valve that shuts off flow in a direction of the charging pressure circuit and is located in a connection line between the control device and the charging pressure circuit.

20. The hydrostatic power-unit as recited in claim 18, wherein the hydraulic accumulator is in communication with the suction side of the power-unit by a connecting line in which the control valve is located, and wherein to supply the control device with hydraulic fluid from the hydraulic accumulator, a hydraulic line is provided which is connected to the connecting line between the control valve and the suction side of the power-unit.

21. The hydrostatic power-unit as recited in claim 20, wherein the hydraulic line is connected to a control pressure line that runs from the charging pressure circuit to the control device, wherein the shutoff valve is located in the control pressure line, and wherein the hydraulic line is connected to the control pressure line between the shutoff valve and the control device.

22. The hydrostatic power-unit as recited in claim 20, including a pressure reducer valve located in the hydraulic line.

23. The hydrostatic power-unit as recited in claim 14, wherein the charge pressure of a charging pressure circuit is the actuation pressure of the actuator device of the check valve.

24. The hydrostatic power-unit as recited in claim 22, including a branch line from the hydraulic line to the actuator device, wherein a shutoff valve that shuts off the flow to the pressure reducer valve is located between the pressure reducer valve and the connection of the branch line.

25. The hydrostatic power-unit as recited in claim 23, wherein the actuator device comprises a positioning piston and a piston pressure chamber of the positioning piston is in communication with the charging pressure circuit and a spring-side piston compression chamber of the positioning piston is depressurized to the tank.

26. The hydrostatic power-unit as recited in claim 14, wherein the check valve includes a control pressure surface and the control pressure surface of the check valve is connected with a charging pressure circuit and an additional control pressure surface is provided on the check valve which actuates the check valve toward the closed position, and wherein the additional control pressure surface for pressurization is connected with the suction side between the power-unit and the check valve.

27. The hydrostatic power-unit as recited in claim 14, including a switching valve for control of the pressurization of the actuator device, by means of which, in a first switched position, the check valve is actuated into the open position as a function of the actuation pressure and by means of which, in a second switched position, the check valve is actuated into the closed position.

28. The hydrostatic power-unit as recited in claim 27, wherein, in the first switched position of the switching valve, a piston pressure chamber of a positioning piston is pressurized with the actuation pressure and a spring-side piston pressure chamber is depressurized to the tank, and in the second switched position of the switching valve, the spring-side piston pressure chamber of the positioning piston is pressurized with the actuation pressure and the piston pressure chamber is depressurized to the tank.

29. The hydrostatic power-unit as recited in claim 27, wherein, in the first switched position of the switching valve, a control pressure surface of the check valve is pressurized with the actuation pressure and an additional control pressure surface of the check valve is connected with the suction side between the power-unit and the check valve.

30. The hydrostatic power-unit as recited in claim 29, wherein, in the second switched position of the switching valve, the control pressure surface and the additional control pressure surface of the check valve are pressurized with the actuation pressure.

31. The hydrostatic power-unit as recited in claim 29, wherein in the second switched position of the switching valve, the control pressure surface is depressurized to the tank and the additional control pressure surface is pressurized with the actuation pressure.

32. The hydrostatic power-unit as recited in claim 27, wherein in the closed position of the check valve, a connection of the suction side with the tank is provided in the direction of flow from the tank to the suction side.

33. The hydrostatic power-unit as recited in claim 17, wherein the control valve and/or the switching valve is/are actuated electrically and is/are in an operative connection with an electronic control device.

34. The hydrostatic power-unit as recited in claim 33, wherein the electronic control device is in communication with a sensor device which measures a speed of rotation of the internal combustion engine and/or a sensor device that measures the pressure of the hydraulic accumulator.

35. The hydrostatic power-unit as recited in claim 14, wherein the hydrostatic power-unit is operable in the same direction of rotation as a pump and as a motor, wherein in pump operation the power-unit supplies at least one user, and wherein in motor operation the power-unit is a hydraulic starter for a start-stop function of the internal combustion engine and/or is a hydraulic booster drive when the internal combustion engine is running.

36. The hydrostatic power-unit as recited in claim 35, wherein for a start-stop function of the internal combustion engine, when the internal combustion engine is shut off, the check valve is actuated by the spring device into the closed position, and after startup of the internal combustion engine by operating the hydrostatic power-unit as a motor, the check valve is actuated into the open position by the hydraulic actuation pressure present at the actuator device generated when the internal combustion engine is running.

37. The hydrostatic power-unit as recited in claim 35, wherein for the booster drive when the internal combustion engine is running, the check valve is actuated into the closed position by the hydraulic actuation pressure for the duration of the operation of the booster drive.
